(19) United States
(12) Patent Application Publication
(10) Pub. No.: US 2009/0046973 A1
(43) Pub. Date: Feb. 19, 2009

(54) Bearing retention method and apparatus

(75) Inventors: Jeffrey R. Lee, Tipton, MI (US); Travis M. Thompson, Ann Arbor, MI (US); Raymond F. Kutchey, Howell, MI (US); Stephen D. Doubler, Saline, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/023,558

(22) Filed: Jan. 31, 2008

Related U.S. Application Data
(60) Provisional application No. 60/956,151, filed on Aug. 16, 2007.

(51) Int. Cl. F16C 35/04

(52) U.S. Cl. 384/572

(57) ABSTRACT

An apparatus for retaining a bearing member within a bore defined by a gear member is provided. The apparatus includes an outer bearing race defining at least one radially extending notch. A tab portion formed on the gear member and extending generally axially therefrom is also provided. The tab portion is deformable to be received within at least a portion of the at least one radially extending notch. The tab portion is operable to limit axial and rotational movement of the outer bearing race within the bore when the tab portion is deformed. A method of retaining the bearing member within the gear member is also provided.

### CROSS-REFERENCE TO RELATED APPLICATIONS

This application claims the benefit of U.S. Provisional Application 60/956,151, filed Aug. 16, 2007, which is hereby incorporated by reference in its entirety.

### TECHNICAL FIELD

The present invention relates to a method and apparatus for retaining a bearing, such as an angular contact bearing, within a gear member.

### BACKGROUND OF THE INVENTION

Roller and ball bearings typically include an inner and outer bearing race having at least one complement of roller or ball elements disposed therebetween. Such bearings may be inserted within a bore defined by a gear member, and operate to provide load support and axial stiffness to the gear member. The bearing has traditionally been retained within the bore by providing a highly-toleranced groove within the bore of the gear member. Once the bearing member is inserted within the bore, a snap ring is provided within the groove to restrict axial movement of the bearing. Rotation of the outer bearing race is typically limited by press fitting the elements or by the use of bonding agents.

### SUMMARY OF THE INVENTION

An apparatus for retaining a bearing member, such as an angular contact bearing, within a bore defined by a gear member is provided. The apparatus includes an outer bearing race of the bearing member. A tab portion formed on the gear member and extending generally axially therefrom is also provided. The tab portion is deformable to engage the outer bearing race. The tab portion is operable to limit axial movement of the outer bearing race within the bore when the tab portion is deformed. The outer race may define at least one radially extending notch such that the tab portion is received within at least a portion of the radially extending notch. In so doing, the tab portion and the radially extending notch cooperate to limit the rotational movement of the outer bearing race.

A method of retaining a bearing member within a bore defined by a gear member is also provided. The method includes the steps of: A) forming at least one axially extending tab portion along the circumferential edge of the gear member; B) forming at least one radially extending notch in a bearing race, such as an outer bearing race, of the bearing member; and C) deforming, such as by orbital forming techniques, the at least one axially extending tab portion to be at least partially received within the at least one radially extending notch of the bearing race to limit axial and rotational movement of the bearing race with respect to the gear member.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a cross sectional view of a portion of an angular contact bearing disposed within a bore defined by a gear member;

FIG. 2 is a cross sectional view of the gear member of FIG. 1 having an axially extending tab portion and an outer bearing race of the angular contact bearing of FIG. 1 defining a radially extending notch;

FIG. 3 is a cross sectional view of the gear member and outer bearing race of FIG. 2 illustrating the axially extending tab portion in a deformed condition such that at least a portion of the axially extending tab portion is received within the notch; and

FIG. 4 is an elevated view of a portion of the of the gear member of FIG. 1; shown in the pre-deformed condition of FIG. 2.

### DESCRIPTION OF THE PREFERRED EMBODIMENTS

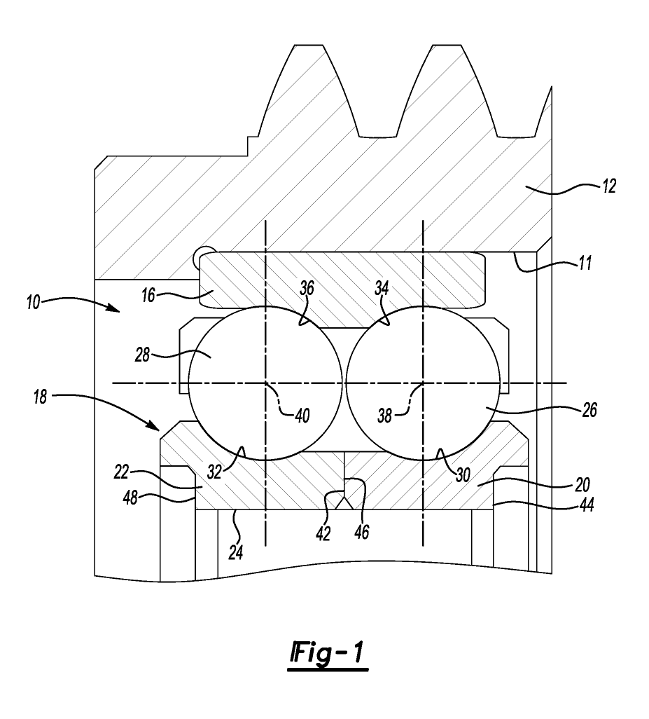

Referring to the drawings, wherein like reference numbers correspond to like or similar components throughout the several views, there is shown in FIG. 1 an angular contact bearing, generally indicated at 10. The angular contact bearing 10 is mounted within a bore 11 defined by a gear member 12, such as a transfer drive gear. The angular contact bearing 10 includes an outer bearing race 16 and an inner bearing race 18. The inner bearing race 18 is characterized as being a split bearing race; that is, the inner bearing race 18 is formed by a first race member 20 and a second race member 22. The inner bearing race 18 defines a bore 24 sufficiently configured to receive a shaft, not shown, therein. A first plurality of roller elements 26, one of which is shown in FIG. 1, is disposed between the outer bearing race 16 and the first race member 20 of the inner bearing race 18. Similarly, a second plurality of roller elements 28, one of which is shown in FIG. 1, is disposed between the outer bearing race 16 and the second race member 22 of the inner bearing race 18. In the embodiment shown, the roller elements 26 and 28 are spherical balls, but those skilled in the art will recognize other roller elements that could be used within the scope of the claims. The first and second plurality of roller elements 26 and 28 cooperate with the outer bearing race 16 and the inner bearing race 18 to provide load support and axial stiffness to the gear member 12.

The first and second plurality of roller elements 26 and 28 run or roll on two pairs of convergent angular pathways. The first and second race members 20 and 22 define first and second outboard pathways 30 and 32, respectively, while the outer bearing race 16 defines first and second inboard pathways 34 and 36. A first ball track 38 is the path that the center of each of the first plurality of roller elements 26 travels within the angular contact bearing 10. Similarly, a second ball track 40 is the path that the center of each of the second plurality of roller elements 28 travels within the angular contact bearing 10. The first race member 20 includes a primary face 42 and a secondary face 44, while the second race member 22 includes a primary face 46 and a secondary face 48. The primary faces 42 and 46 cooperate to provide the necessary clearances between the first and second plurality of roller elements 26 and 28, the inner bearing race 18, and the outer bearing race 16. Therefore, the dimensional tolerances of the primary faces 42 and 46 must be maintained to ensure the reliability and proper functioning of the angular contact bearing 10. It is preferred to retain the angular contact bearing 10 within the bore 11 to limit the axial movement of the angular contact bearing 10 and to preload the angular contact bearing 10. Additionally, rotation of the outer bearing race 16 in relation to the gear member 12 is undesirable. A preferred method and apparatus to retain the angular contact bearing 10 within the bore 11 of gear member 12 will be discussed in detail below.

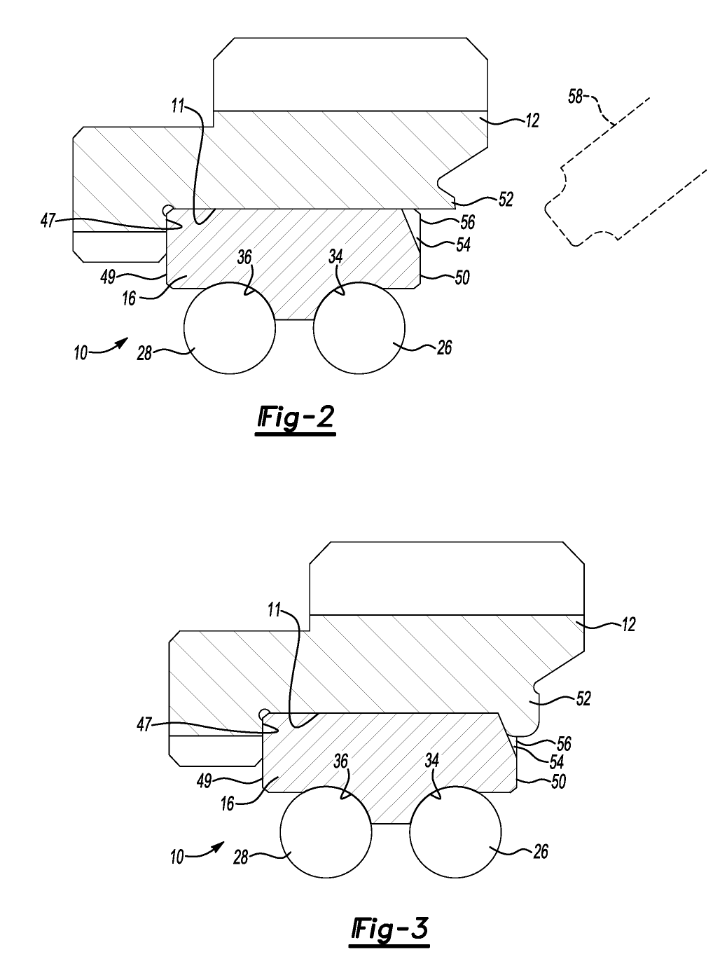

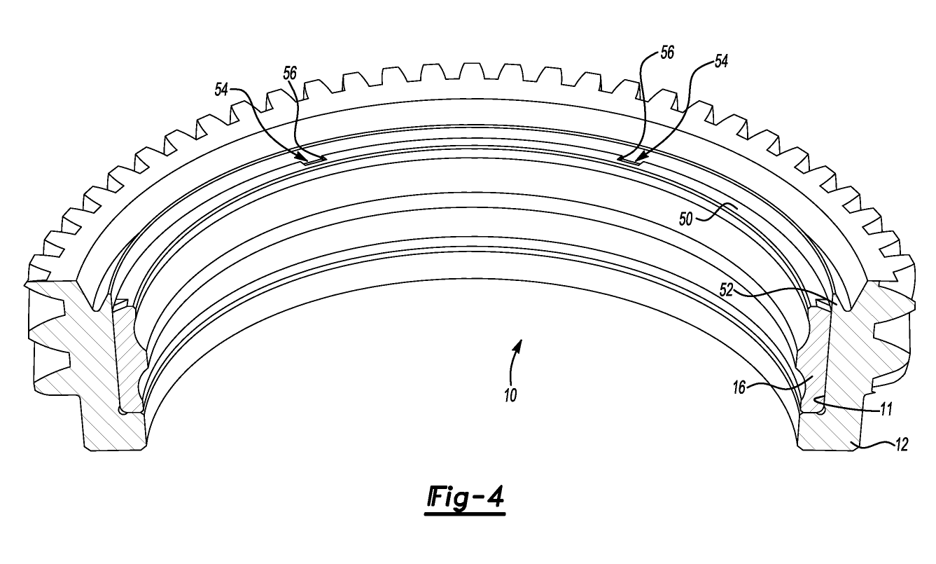

Referring now to FIG. 2, and with continued reference to FIG. 1, there is shown the gear member 12 having a portion of the angular contact bearing 10 disposed within the bore 11. The gear member 12 includes a generally radially projecting land 47 operable to engage an axial face 49 of the outer bearing race 16 to position the outer bearing race 16 within the bore 11. The outer bearing race 16 further includes an axial face 50 disposed opposite the axial face 49. The gear member 12 includes an axially extending tab portion 52 formed by methods known in the art, such as turning, grinding, forging, etc. In a preferred embodiment, the axially extending tab portion 52 extends continuously, or substantially continuously, around the circumference of the gear member 12, forming a deformable lip or ridge; FIGS. 2 and 3 show only a cross section of axially extending tab portion 52. The outer bearing race 16 defines a notch 54 that extends generally radially toward the bore 11 of the gear member 12. In a preferred embodiment, the notch 54 generally tapers away from the bore 11 of the gear member 12 toward the axial face 50 of the outer bearing race 16. The notch 54 forms a plurality of projections 56, one of which is shown in FIG. 2.

FIG. 4 shows an elevated view of a portion of the gear member 12 having a portion of the angular contact bearing 10 disposed within the bore 11. This Figure shows the (un-deformed) axially extending tab portion 52 extending continuously, or substantially continuously, around the circumference of the gear member 12, forming a deformable lip or ridge. The notch 54 and projections 56 can be seen at multiple areas around the outer bearing race 16.

The axially extending tab portion 52 is axially and radially deformable such that at least a portion of the axially extending tab portion 52 is receivable within the notch 54, as shown in FIG. 3. The remainder of the deformed axially extending tab portion 52 contacts the areas of axial face 50 which do not have the notch 54 or projections 56. In a preferred embodiment, the axially extending tab portion 52 is deformed by orbital or roller forming techniques, as are known in the art, wherein a forming tool 58, shown in broken lines in FIG. 2, is biased against the axially extending tab portion 52 thereby causing the deformation thereof. Following deformation, the axially extending tab portion 52 would be engaged with the notch 54 at each of the plurality of projections 56, spaced circumferentially around the lip of the outer bearing race 16.

Referring to FIG. 3, there is shown the gear member 12 having a portion of the angular contact bearing 10 disposed within the bore 11, and specifically showing the axially extending tab portion 52 in the deformed condition. In the deformed condition, a portion of the axially extending tab portion 52 is received within the notch 54 and operates to bias the outer bearing race 16 against the land 47 of the gear member 12. The remainder of the deformed axially extending tab portion 52 contacts the areas of axial face 50 which do not have the notch 54 or projections 56, further biasing outer bearing race 16 against the land 47 of the gear member 12. In so doing, the axial movement of the angular contact bearing 10 within the bore 11 is substantially restricted. Additionally, in the deformed condition, the axially extending tab portion 52 engages the projection 56 to substantially limit the rotational movement of the outer bearing race 16 with respect to the gear member 12. Note again that, in a preferred embodiment, the outer bearing race 16 and notch 54 include multiple projections 56, each of which would receive a portion of the axially extending tab portion 52. As best viewed in the pre-deformed state of FIG. 4, following deformation of axially extending tab portion 52, axial movement will be limited by contact between both the axial face 50 and the notch 54 and the deformed axially extending tab portion 52; while radial movement will be limited by contact between the projections 56 and deformed axially extending tab portion 52. By employing the notch 54 and the axially extending tab portion 52 to retain the outer bearing race 16 within the bore 11, the need for additional parts, such as snap rings, and precision machining to form a groove in the gear member 12—to receive the snap ring therein—is obviated; thereby reducing cost and complexity of the assembly.

A method of retaining the angular contact bearing 10 within the gear member 12 is also provided. The method includes the steps of forming at least one of the axially extending tab portions 52 on the gear member 12 and forming at least one of the radially extending notches 54 in the outer bearing race 16 of the angular contact bearing 10. Subsequently, the at least one axially extending tab portion 52 is deformed, preferably by orbital or roller forming techniques, to engage the at least one radially extending notch 54 of the outer bearing race 16 to limit axial and rotational movement of the outer bearing race 16 with respect to the gear member 12.

The discussion hereinabove has focused on an apparatus and method to retain the angular contact bearing 10 within a bore 11 defined by the gear member 12. Those skilled in the art will recognize that the apparatus and method may be employed to retain other types of bearings, such as a single row roller bearing, within the bore 11 defined by the gear member 12 while remaining within the scope of the claims. While the best modes for carrying out the invention have been described in detail, those familiar with the art to which this invention relates will recognize various alternative designs and embodiments for practicing the invention within the scope of the appended claims.

1. An apparatus for retaining a bearing member within a bore defined by a gear member, the apparatus comprising:
an outer bearing race;
a tab portion formed on the gear member and extending generally axially therefrom, said tab portion being deformable to engage said outer bearing race; and
wherein said tab portion is operable to limit axial movement of said outer bearing race within the bore when said tab portion is in a deformed condition.

2. The apparatus of claim 1, wherein said outer bearing race defines at least one radially extending notch and wherein at least a portion of said tab portion is received within at least a portion of said at least one radially extending notch such that the rotational movement of the outer bearing race within the bore is limited when said tab portion is in a deformed condition.

3. The apparatus of claim 1, further characterized by the absence of a snap ring.

4. The apparatus of claim 1, wherein the bearing member is an angular contact bearing.

5. The apparatus of claim 1, wherein said tab portion extends substantially circumferentially around the gear member.

6. The apparatus of claim 1, wherein said tab portion forms a continuous circumferential lip around the gear member.

7. A method of retaining a bearing member within a bore defined by a gear member comprising:
forming at least one axially extending tab portion on the gear member; and
deforming said at least one axially extending tab portion to engage a bearing race such that axial movement of said bearing race with respect to the gear member is limited.

8. The method of claim 7, further comprising:
forming at least one radially extending notch in said bearing race of the bearing member; and
deforming said at least one axially extending tab portion to be at least partially received within said at least one radially extending notch of said bearing race such that axial and rotational movement of said bearing race with respect to the gear member is limited.

9. The method of claim 8, wherein deforming said axially extending tab portion is by orbital forming.

10. The method of claim 8, wherein deforming said axially extending tab portion is by roller forming.

11. The method of claim 8, wherein the bore is characterized by lack of a snap ring grove.

12. The method of claim 8, wherein said bearing race is an outer bearing race.

13. The method of claim 8, wherein said tab portion extends substantially circumferentially around the gear member.

14. The method of claim 8, wherein said tab portion forms a continuous circumferential lip around the gear member.

15. An apparatus for retaining a bearing member within a bore defined by a gear member, the apparatus comprising:
an outer bearing race;
a tab portion formed on the gear member and extending generally axially therefrom, said tab portion being deformable to engage said outer bearing race;
wherein said tab portion is operable to limit axial movement of said outer bearing race within the bore when said tab portion is in a deformed condition; and
wherein said outer bearing race defines at least one radially extending notch and wherein at least a portion of said tab portion is received within at least a portion of said at least one radially extending notch such that the rotational movement of the outer bearing race within the bore is limited when said tab portion is in a deformed condition.

16. The apparatus of claim 15, wherein the bearing member is an angular contact bearing.

17. The apparatus of claim 15, wherein said tab portion extends substantially circumferentially around the gear member.

18. The apparatus of claim 15, further characterized by the absence of a snap ring.

19. The apparatus of claim 15, wherein the bearing member is a roller contact bearing.
